(19) United States
(12) Patent Application Publication
(10) Pub. No.: US 2026/0367307 A1
(43) Pub. Date: Nov. 19, 2026

(54) Light Guide Assembly

(71) Applicant: Siemens Aktiengesellschaft, München (DE)

(72) Inventors: Yu Xia Pan, Chengdu, SC (CN); Ting Li Lan, Chengdu, SC (CN); Tie Qiang Zhang, Chengdu, SC (CN); Chang Sen Chen, Chengdu, SC (CN); Zhan Bo Ren, Chengdu, SC (CN)

(73) Assignee: Siemens Aktiengesellschaft, München (DE)

(21) Appl. No.: 19/475,506

(22) PCT Filed: Apr. 17, 2023
(86) PCT No.: PCT/CN2023/088719

§ 371 Date: Oct. 15, 2025

(51) Int. Cl. F21V 8/00

(52) U.S. Cl. CPC G02B 6/0091; G02B 6/0073

(57) ABSTRACT

The present disclosure describes light guide assemblies for an electronic device including a housing and a light guide element. The assembly includes first light guide columns capable of receiving light from LED lights on the printed circuit board and guiding the light to a first indicator terminal running through a first observation hole. Second light guide columns are capable of receiving light from LED lights on another board surface of the printed circuit board to a second indicator terminal running through the second observation hole.

### CROSS-REFERENCE TO RELATED APPLICATIONS

This application is a U.S. National Stage Application of International Application No. PCT/CN2023/088719 filed Apr. 17, 2023, which designates the United States of America, the contents of which are hereby incorporated by reference in their entirety.

### TECHNICAL FIELD

The present disclosure relates to electronic devices. Various embodiments of the teachings herein include light guide assemblies and light guide assemblies for electronic devices.

### BACKGROUND

In an electronic device, where LEDs (light emitting diodes) on a printed circuit board (PCB) and observation holes in a housing fail to be arranged in one-to-one correspondence in a straight line, generally customized light guide columns are disposed on the electronic device to avoid mutual interference caused by light of the LEDs. Where LEDs are arranged on both sides of the printed circuit board, a portion of the printed circuit board needs to be inserted between the light guide columns to reach an assembly position. In this case, the entire structure is complicated, and the assembly is inconvenient.

### SUMMARY

Teaching of the present disclosure provide light guide assemblies for an electronic device. The light guide assembly has a simple structure and is easy for assembly on a printed circuit board. For example, some embodiments of the teachings herein include a light guide assembly for an electronic device, the electronic device comprising a printed circuit board, a plurality of LED lights being disposed on each of two board surfaces at an edge of the printed circuit board, the light guide assembly comprising: a housing (10) provided with an indicator panel (11), wherein the printed circuit board is capable of being disposed perpendicular to the indicator panel (11) on the housing (10), and a row of first observation holes (111) and a row of second observation holes (112) are defined in the indicator panel (11), the row of first observation holes (111) and the row of second observation holes (112) being respectively arranged along a first direction (X), the first direction (X) being parallel to the printed circuit board and the indicator panel (11); and a light guide element (20), capable of being fixed to the indicator panel (11), wherein the light guide element (20) comprises: a group of first light guide columns (21), arranged along the first direction (X), wherein each of the first light guide columns (21) has a first indicator terminal (211) running through the first observation hole (111), and the first light guide column (21) is capable of receiving light from the LED light on one of the board surfaces of the printed circuit board along a second direction (Y) perpendicular to the printed circuit board and guiding the light to the first indicator terminal (211), and a group of second light guide columns (22), arranged along the first direction (X), wherein each of the second light guide columns (22) is disposed on a side of the printed circuit board along a third direction (Z) perpendicular to the indicator panel (11), each of the second light guide columns (22) has a second indicator terminal (221) running through the second observation hole (112), and the second light guide column (22) is capable of receiving light from the LED light on the other of the board surfaces of the printed circuit board along the third direction (Z) and guiding the light to the second indicator terminal (221).

In some embodiments, each of the first light guide columns (21) has a first receiving surface (212) perpendicular to the second direction (Y) and a first refraction surface (213), wherein light entering the first light guide column (21) from the first receiving surface (212) along the second direction (Y) is refracted by the first refraction surface (213), propagated along the third direction (Z), and guided out from the first indicator terminal (211).

In some embodiments, each of the second light guide columns (22) has a second receiving surface (222) perpendicular to the third direction (Z) and two second refraction surfaces (223), wherein the two second refraction surfaces (223) are capable of successively refracting light entering from the second receiving surface (222) along the third direction (Z) to light traveling along the third direction (Z), and guiding out the light from the second indicator terminal (221).

In some embodiments, the light guide columns are integrally formed, and the light guide element (20) further comprises: a plurality of transverse connection ribs (23), wherein each of the transverse connection ribs (23) is connected to adjacent two of the first light guide columns (21) or adjacent two of the second light guide columns (22) along the first direction (X); and two longitudinal connection ribs (24), wherein one of the longitudinal connection ribs (24) is connected to the first light guide column (21) and the second light guide column (22) arranged on one end along the first direction (X), and the other of the longitudinal connection ribs (24) is connected to the first light guide column (21) and the second light guide column (22) arranged on the other end along the first direction (X).

In some embodiments, the light guide element (20) further comprises two reinforcement ribs (25), wherein one of the reinforcement ribs (25) is connected to each of the first light guide columns (21) and each of the transverse connection ribs (23) connecting the first light guide columns (21), and the other of the reinforcement ribs (25) is connected to each of the second light guide columns (22) and each of the transverse connection ribs (23) connecting the second light guide columns (22).

In some embodiments, the indicator panel (11) is provided with two snaps (113) and a plurality of stop blocks (114), wherein the two snaps (113) are disposed along the first direction (X), the two longitudinal connection ribs (24) are capable of engaging with the two snaps (113), the two snaps (113) are abutted against the two longitudinal connection ribs (24) to restrict a position of the light guide element (20) in the first direction (X), and abutted against the transverse connection ribs (23) in cooperation with the plurality of stop blocks (114) to restrict a position of the light guide element (20) in the third direction (Z), the plurality of stop blocks (114) are further capable of abutting against the transverse connection rib (23) and the reinforcement rib (25) along a direction reverse to the second direction (Y), and abutting against the two longitudinal connection ribs (24) along the second direction in cooperation with the printed circuit board to restrict a position of the light guide element (20) in the second direction (Y).

In some embodiments, a drive bevel (242) is defined at one end, close to the indicator panel (11) along the third direction (Z), of each of the longitudinal connection ribs (24), wherein the drive bevel (242) is capable of driving the snap (113) to deform along the first direction (X).

In some embodiments, each of the transverse connection ribs (23) comprises two connection portions (232), wherein each of the connection portions (232) is connected to one of the first light guide columns (21) or one of the second light guide columns (22) along the first direction (X), and the two connection portions (232) are connected along a direction perpendicular to the first direction (X).

As another example, some embodiments include an electronic device, comprising: a printed circuit board (30), wherein a plurality of LED lights (32) are disposed on each of two board surfaces at an edge of the printed circuit board; and the light guide assembly as described herein, wherein the first light guide column (21) is capable of receiving light from the LED light on one of the board surfaces of the printed circuit board along a second direction (Y) perpendicular to the printed circuit board and guiding the light to the first indicator terminal (211), the second light guide column (22) is capable of receiving light from the LED light on the other of the board surfaces of the printed circuit board along the third direction (Z) and guiding the light to the second indicator terminal (221).

In some embodiments, the LED light (32) on one board surface of the printed circuit board (30) is configured to emit the light to the second light guide column (22) along the third direction (Z).

### BRIEF DESCRIPTION OF THE DRAWINGS

The accompanying drawings are merely for schematic and illustrative description and demonstration of the teachings of the present disclosure, instead of limiting the scope thereof. In the drawings:

FIG. 1 is a partial sectional view showing a light guide assembly for an electronic device incorporating teachings of the present disclosure;

FIG. 2 is a partial sectional view showing the light guide assembly in FIG. 1;

FIG. 3 is schematic structural view showing a light guide element of the light guide assembly in FIG. 1;

FIG. 4 is schematic structural view showing the light guide element in FIG. 3 at another view angle;

FIG. 5 is another schematic partial view showing the light guide assembly incorporating teachings of the present disclosure;

FIG. 6 is a partial sectional view showing the light guide assembly in FIG. 5;

FIG. 7 is another partial sectional view showing the light guide assembly in FIG. 5; and

FIG. 8 is a schematic structural view showing the light guide element of the light guide assembly incorporating teachings of the present disclosure.

### REFERENCE NUMERALS AND DENOTATIONS THEREOF

10—housing
11—indicator panel
111—first observation hole
112—second observation hole
113—snap
114—stop block
20—light guide element
21—first light guide column
211—first indicator terminal
212—first receiving surface
213—first refraction surface
22—second light guide column
221—second indicator terminal
222—second receiving surface
223—second refraction surface
23—transverse connection rib
232—connection portion
24—longitudinal connection rib
242—drive bevel
25—reinforcement rib
30—printed circuit board
32—LED light
X—first direction
Y—second direction
Z—third direction

### DETAILED DESCRIPTION

The present disclosure describes various light guide assemblies for an electronic device. The electronic device includes a printed circuit board. A plurality of LED lights are disposed on two board surfaces at an edge of the printed circuit board. The light guide assembly includes a housing and a light guide element. The housing is provided with an indicator panel, wherein the printed circuit board is capable of being disposed perpendicular to the indicator panel on the housing, and a row of first observation holes and a row of second observation holes are defined in the indicator panel. The row of first observation holes and the row of second observation holes are respectively arranged along a first direction, wherein the first direction is parallel to the printed circuit board and the indicator panel.

The light guide element is capable of being fixed to the indicator panel, and the light guide element includes a group of first light guide columns and a group of second light guide columns. The group of first light guide columns is arranged along the first direction, wherein each of the first light guide columns has a first indicator terminal running through the first observation hole, and the first light guide column is capable of receiving light from the LED light on one of the board surfaces of the printed circuit board along a second direction perpendicular to the printed circuit board and guiding the light to the first indicator terminal. The group of second light guide columns is arranged along the first direction, wherein each of the second light guide columns is disposed on a side of the printed circuit board along a third direction perpendicular to the indicator panel, each of the second light guide columns has a second indicator terminal running through the second observation hole, and the second light guide column is capable of receiving light from the LED light on the other of the board surfaces of the printed circuit board along the third direction and guiding the light to the second indicator terminal.

The light guide element is provided with two different groups of light guide columns. First ends of one group of the first light guide columns are disposed on a side of the printed circuit board along a direction perpendicular to the printed circuit board, and are capable of receiving light from the LED lights along the direction perpendicular to the printed circuit board and guiding the light to the observation holes in the indicator panel. The other group of the second light guide columns is disposed on a side of the printed circuit board along a direction perpendicular to the indicator panel, and the second light guide columns in this group are capable of receiving light from the LED lights along the direction perpendicular to the indicator panel and guiding the light to the observation holes in the indicator panel. The light guide assembly has a simple structure, and the two groups of light guide columns receive light in directions perpendicular to each other to avoid interference with each other. In this way, the printed circuit board is not blocked by the light guide columns and is thus capable of being horizontally assembled into the housing, which facilitates assembly.

In some embodiments, each of the first light guide columns has a first receiving surface perpendicular to the second direction and a first refraction surface. Light entering the first light guide column from the first receiving surface along the second direction is refracted by the first refraction surface, propagated along the third direction, and guided out from the first indicator terminal.

In some embodiments, each of the second light guide columns has a second receiving surface perpendicular to the third direction and two second refraction surfaces. The two second refraction surfaces are capable of successively refracting light entering from the second receiving surface along the third direction to light traveling along the third direction, and guiding out the light from the second indicator terminal.

In some embodiments, the light guide columns are integrally formed, and the light guide element further includes a plurality of transverse connection ribs and two longitudinal connection ribs. Each of the transverse connection ribs is connected to adjacent two of the first light guide columns or adjacent two of the second light guide columns along the first direction. One of the longitudinal connection ribs is connected to the first light guide column and the second light guide column arranged on one end along the first direction, and the other of the longitudinal connection ribs is connected to the first light guide column and the second light guide column arranged on the other end along the first direction. The above-described structure facilitates manufacture of the light guide element, effectively reduces the manufacture cost, and meanwhile ensures structural stability of the light guide element.

In some embodiments, the light guide element further includes two reinforcement ribs. One of the reinforcement ribs is connected to each of the first light guide columns and each of the transverse connection ribs connecting the first light guide columns, and the other of the reinforcement ribs is connected to each of the second light guide columns and each of the transverse connection ribs connecting the second light guide columns. The above-described structure enhances structural stability of the light guide element.

In some embodiments, the indicator panel is provided with two snaps and a plurality of stop blocks. The two snaps are disposed along the first direction, the two longitudinal connection ribs are capable of engaging with the two snaps, and the two snaps are abutted against the two longitudinal connection ribs to restrict a position of the light guide element in the first direction, and abutted against the transverse connection ribs in cooperation with the plurality of stop blocks to restrict a position of the light guide element in the third direction. The plurality of stop blocks are further capable of abutting against the transverse connection rib and the reinforcement rib along a direction reverse to the second direction and abutting against two longitudinal connection ribs along the second direction in cooperation with the printed circuit board to restrict a position of the light guide element in the second direction. With the above-described structure, the light guide element is conveniently assembled on the indicator panel, and the assembly position is accurate and the fixation secure.

In some embodiments, a drive bevel is defined at one end, close to the indicator panel along the third direction, of each of the longitudinal connection ribs, wherein the drive bevel is capable of driving the snap to deform along the first direction. The above-described structure facilitates assembly of the light guide element.

In some embodiments, each of the transverse connection ribs includes two connection portions. Each of the connection portions is connected to one of the first light guide columns or one of the second light guide columns along the first direction, and the two connection portions are connected along a direction perpendicular to the first direction. The above-described structure effectively avoids mutual interference between two adjacent first light guide columns or between two adjacent second light guide columns.

The present disclosure further describes some example electronic device. The electronic device includes a printed circuit board, and one of the light guide assemblies as described herein. The first light guide column is capable of receiving light from the LED light on one of the board surfaces of the printed circuit board along a second direction perpendicular to the printed circuit board and guiding the light to the first indicator terminal, the second light guide column is capable of receiving light from the LED light on the other of the board surfaces of the printed circuit board along the third direction and guiding the light to the second indicator terminal.

In some embodiments, the LED light on one board surface of the printed circuit board is configured to emit the light to the second light guide column along the third direction. In this way, light received by the second light guide column is increased, and luminance at the second indicator terminal is enhanced.

For clearer descriptions of the technical features, objects, and the technical effects of the present disclosure, some specific embodiments of the present disclosure are hereinafter described with reference to the accompanying drawings. In the drawings, like reference numerals denote elements having the same structure or having the similar structure but the same function.

In this text, the term “exemplary” or “schematic” is used herein to mean “serving as an example, instance, or illustration,” and any illustration or embodiment described herein as “exemplary” shall not be necessarily construed as preferred or advantageous over other illustrations or embodiments.

In this text, the terms “first,” “second,” and the like do not represent degrees of importance or a sequence, but only for differentiation, and for ease of description.

For brevity, parts relevant to the present disclosure are merely illustrated in the drawings, and these parts do not denote the actual structure of the product.

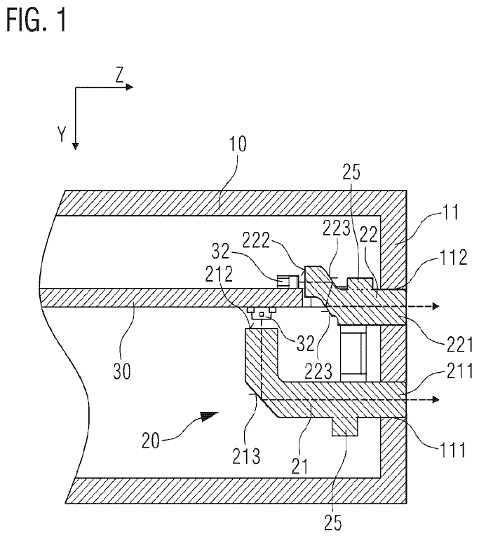

FIG. 1 is a partial sectional view showing a light guide assembly for an electronic device incorporating teachings of the present disclosure. Referring to FIG. 1, the electronic device includes a printed circuit board 30. A plurality of LED lights 32 are disposed on each of two board surfaces at an edge of the printed circuit board 30. The light guide assembly includes a housing 10 and a light guide element 20.

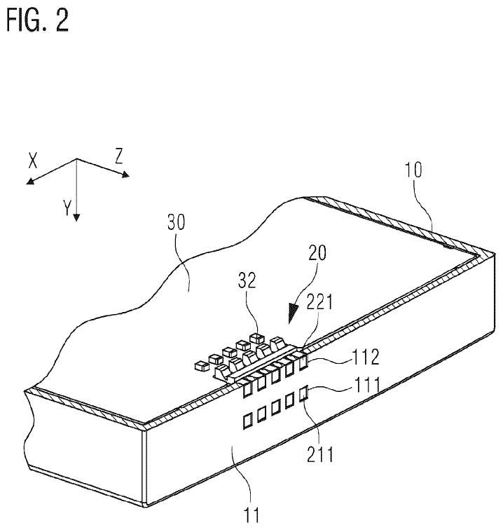

FIG. 2 is a partial sectional view showing the light guide assembly in FIG. 1. Referring to FIG. 1 and FIG. 2, the housing 10 is provided with an indicator panel 11. The printed circuit board 30 is capable of being disposed perpendicular to the indicator panel 11 on the housing 10, and a row of first observation holes 111 (only one of the observation holes 111 is illustrated in FIG. 2) and a row of second observation holes 112 (only one of the observation holes 112 is illustrated in FIG. 2) are defined in the indicator panel 11. The row of first observation holes 111 and the row of second observation holes 112 are respectively arranged along a first direction X (a direction perpendicular to the page face as illustrated in FIG. 1), wherein the first direction X is parallel to the printed circuit board 30 and the indicator panel 11.

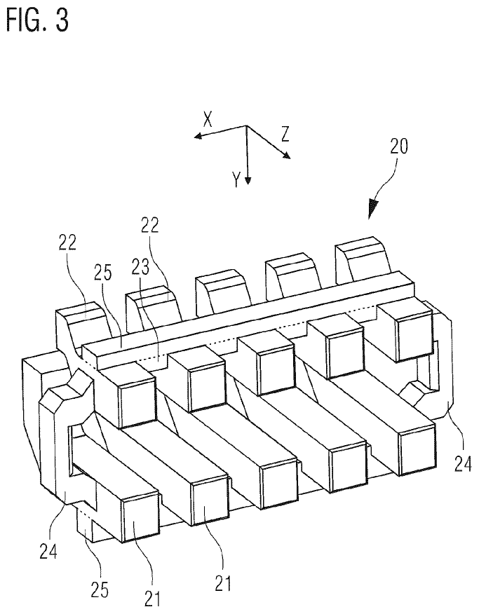

The light guide element 20 is capable of being fixed to the indicator panel 11. FIG. 3 is schematic structural view showing a light guide element of the light guide assembly in FIG. 1. Referring to FIG. 1 and FIG. 3, the light guide element 20 includes a group of first light guide columns 21 (only two of the first light guide columns 21 are illustrated in FIG. 3) and a group of second light guide columns 22 (only two of the second light guide columns 22 are illustrated in FIG. 2).

The group of first light guide columns 21 is arranged along the first direction X, and each of the first light guide columns 21 has a first indicator terminal 211 running through the first observation hole 111. One end of the first light guide column 21 is disposed on a side of the printed circuit board 30 along a second direction Y perpendicular to the printed circuit board 30, and this end of the first light guide column 21 is capable of receiving light on one of board surfaces of the printed circuit board 30 along the second direction Y and guiding the light to the first indicator terminal 211.

The group of second light guide columns 22 is arranged along the first direction X, wherein each of the second light guide columns 22 is disposed on a side of the printed circuit board 30 along a third direction Z perpendicular to the indicator panel 11, each of the second light guide columns 22 has a second indicator terminal 221 running through the second observation hole 112, and the second light guide column 22 is capable of receiving light from the LED light 32 on the other of the board surfaces of the printed circuit board 30 along the third direction Z and guiding the light to the second indicator terminal 221.

In the light guide assembly for an electronic device shown, the light guide element 20 is provided with two different groups of light guide columns. One ends of one group of the first light guide columns 21 are disposed on a side of the printed circuit board 30 along the first direction X perpendicular to the printed circuit board 30, and are capable of receiving light from the LED lights 32 along the first direction X and guiding the light to the first indicator terminal 211, and thus guiding the light out from the first observation holes 111 in the indicator panel 11. The other group of the second light guide columns 22 is disposed on a side of the printed circuit board 30 along the second direction Y, and the second light guide columns 22 in this group are capable of receiving light from the LED lights 32 along the second direction Y and guiding the light to the second indicator terminal 221, and thus guiding the light out from the second observation holes 112 in the indicator panel 11. The light guide assembly has a simple structure, and the two groups of light guide columns receive light in directions perpendicular to each other to avoid interference to each other. In this way, the printed circuit board 30 is not blocked by the light guide columns and is thus capable of being horizontally assembled into the housing, which facilitates assembly.

In some embodiments, such as that shown in FIG. 1, each of the first light guide columns 21 has a first receiving surface 212 perpendicular to the second direction Y and a first refraction surface 213. Light entering the first light guide column 21 from the first receiving surface 212 along the second direction Y is refracted by the first refraction surface 213, propagated along the third direction Z, and guided out from the first indicator terminal 211. A distance between the first refraction surface 213 and the first receiving surface 212 may be adjusted according to a position of the first observation hole 111. Each of the second light guide columns 22 has a second receiving surface 222 perpendicular to the third direction Z and two second refraction surfaces 223. The two second refraction surfaces 223 are capable of successively refracting light entering from the second receiving surface 222 along the third direction Z to light traveling along the third direction Z, and guiding out the light from the second indicator terminal 221. A distance between the two second refraction surfaces 223 may be adjusted according to a position of the second observation hole 112.

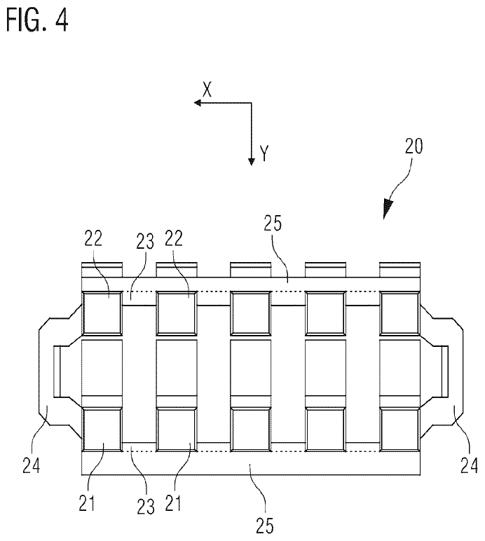

FIG. 4 is schematic structural view showing the light guide element in FIG. 3 at another view angle. Referring to FIG. 3 and FIG. 4, the light guide columns are integrally formed. The light guide element 20 further includes a plurality of transverse connection ribs 23 (only one of the connection ribs 23 is illustrated in FIG. 3) and two longitudinal connection ribs 24. Each of the transverse connection ribs 23 is connected to adjacent two of the first light guide columns 21 or adjacent two of the second light guide columns 22 along the first direction X. As illustrated in FIG. 4, one of the longitudinal connection ribs 24 is connected to the first light guide column 21 and the second light guide column 22 arranged on one end along the first direction X, and the other of the longitudinal connection ribs 24 is connected to the first light guide column 21 and the second light guide column 22 arranged on the other end along the first direction X. The above-described structure facilitates manufacture of the light guide element 20, effectively reduces the manufacture cost, and meanwhile ensures structural stability of the light guide element 20.

Referring to FIG. 3 and FIG. 4, the light guide element 20 further includes two reinforcement ribs 25. One of the reinforcement ribs 25 is connected to each of the first light guide columns 21 and each of the transverse connection ribs 23 connecting the first light guide columns 21, and the other of the reinforcement ribs 25 is connected to each of the second light guide columns 22 and each of the transverse connection ribs 23 connecting the second light guide columns 22. The two reinforcement ribs 25 are capable of enhancing structural strengths of connection of the group of first light guide columns 21 and connection of the group of second light guide columns 22. In addition, the light fails to be propagated inside the group of first light guide columns 21 or the group of second light guide columns 22 via the reinforcement ribs 25, such that structural stability of the light guide element 20 is enhanced without increasing any light interference.

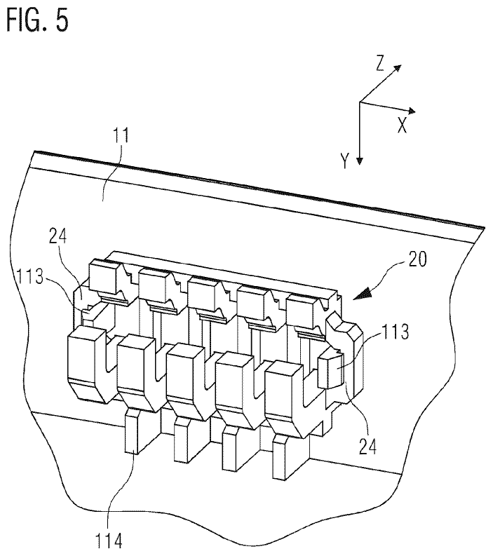

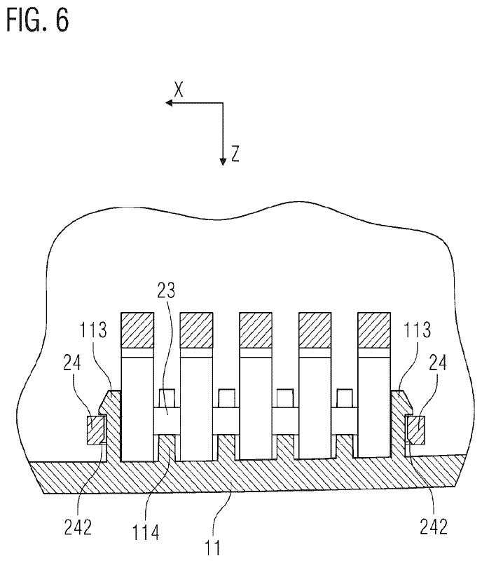

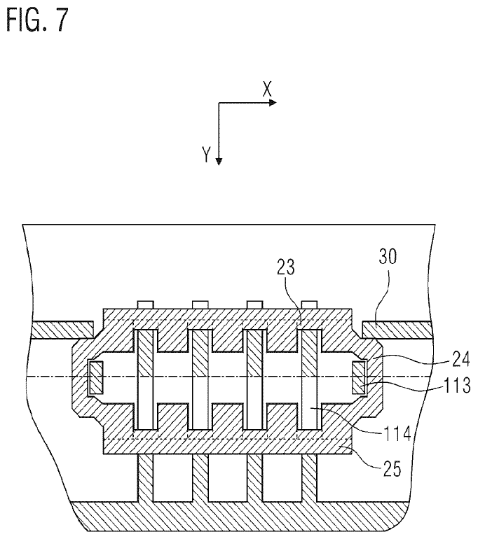

FIG. 5 is another schematic partial view showing an example light guide assembly incorporating teachings of the present disclosure. FIG. 6 and FIG. 7 are partial sectional views showing the light guide assembly in FIG. 5. Referring to FIG. 5, FIG. 6, and FIG. 7, parts identical or similar to the light guide assembly in FIG. 1 are not described any further. With respect to the light guide assembly, the difference lies in that the indicator panel 11 is provided with two snaps 113 and a plurality of stop blocks 114 (only one of the snaps 113 and only one of the stop blocks 114 are illustrated in FIG. 5, FIG. 6, and FIG. 7).

The two snaps 113 are arranged along the first direction X, and the two longitudinal connection ribs 24 are capable of engaging with the two snaps 113. The two snaps 113 are disposed on an inner side of the two longitudinal connection ribs 24, and are abutted against the two longitudinal connection ribs 24 along the first direction X to restrict a position of the light guide element 20 in the first direction X. The two snaps 113 are further abutted against the two longitudinal connection ribs 24 along the third direction Z, and are abutted against the transverse connection ribs 23 along the third direction Z in cooperation with the plurality of stop blocks 114 to restrict a position of the light guide element 20 in the third direction Z. The plurality of stop blocks 114 are further capable of abutting against the transverse connection rib 23 and the reinforcement rib 25 along a direction reverse to the second direction Y, and abutting against the two longitudinal connection ribs 24 along the second direction Y in cooperation with the printed circuit board 30 to restrict a position of the light guide element 20 in the second direction Y. With the above-described structure, the light guide element 20 is conveniently assembled on the indicator panel 11, and is capable of restricting movement of the light guide element 20 along three directions perpendicular to each other upon assembly on the printed circuit board, such that the assembly position is accurate and the fixation is secure.

Referring to FIG. 6, a drive bevel 242 is defined at one end, close to the indicator panel 11 along the third direction Z, of each of the longitudinal connection ribs 24, wherein the drive bevel 242 is capable of driving the snap 113 to deform along the first direction X. In the case that the light guide element 20 is assembled on the indicator panel 11, the two drive bevels 242 are capable of pushing the snaps 113 between the two longitudinal connection ribs 24, such that the light guide element 20 is more conveniently assembled.

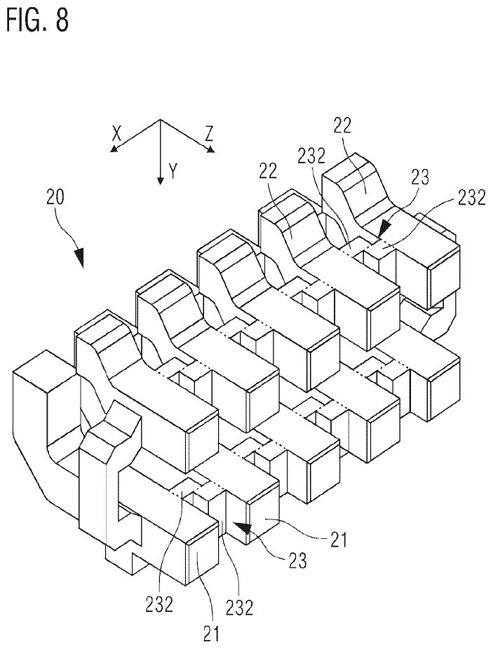

FIG. 8 is a schematic structural view showing a light guide element of the light guide assembly incorporating teachings of the present disclosure. Referring to FIG. 8, parts identical or similar to the light guide element in FIG. 3 are not described any further. With respect to the light guide element, the difference lies in that each of the transverse connection ribs 23 includes two connection portions 232. Each of the connection portions 232 is connected to one of the first light guide columns 21 or one of the second light guide columns 22 along the first direction X, and the two connection portions 232 are connected along a direction perpendicular to the first direction X. The two connection portions 232 are connected in a misalignment fashion in the first direction X, such that the light fails to be propagated inside the connection portions 232 along the first direction X. In this way, mutual interference is effectively avoided between two adjacent first light guide columns 21 or between two adjacent second light guide columns 22.

Referring to FIG. 1, the electronic device includes a printed circuit board 30, and the light guide assembly as described above.

A plurality of LED lights 32 are disposed on each of two board surfaces at an edge of the printed circuit board 30. The first light guide column 21 is capable of receiving light from the LED light on one of the board surfaces of the printed circuit board along a second direction Y perpendicular to the printed circuit board and guiding the light to the first indicator terminal 211, the second light guide column 22 is capable of receiving light from the LED light on the other of the board surfaces of the printed circuit board along the third direction Z and guiding the light to the second indicator terminal 221. In an exemplary embodiment, the LED light 32 on one board surface of the printed circuit board 30 is configured to emit the light to the second light guide column 22 along the third direction Z. In this way, light received by the second light guide column 22 is increased, and luminance at the second indicator terminal 221 is enhanced.

It should be understood that, although this specification is described based on the embodiments, not each of the embodiments discloses an independent technical solution. Such description manner of the specification is only for clarity. A person skilled in the art should consider the specification as an entirety. The technical solutions according to the embodiments may also be suitably combined to derive other embodiments that may be understood by a person skilled in the art.

A series of detailed descriptions given in this specification are merely intended to illustrate feasible embodiments of the present disclosure, instead of limiting the protection scope of the present disclosure. Any equivalent embodiments or modifications, for example, combinations, segmentations, or repetition of features, derived without departing from the spirit of the present disclosure shall fall within the protection scope of the present disclosure.

What is claimed is:

1. A light guide assembly for an electronic device having a printed circuit board and a plurality of light emitting diode (LED) lights disposed on each of two board surfaces at an edge of the printed circuit board, the light guide assembly comprising:
a housing with an indicator panel, wherein the printed circuit board is capable of being disposed perpendicular to the indicator panel on the housing;
a row of first observation holes in the indicator panel;
a row of second observation holes in the indicator panel;
wherein the row of first observation holes and the row of second observation holes are respectively arranged along a first direction parallel to the printed circuit board and the indicator panel; and
a light guide element fixed to the indicator panel, wherein the light guide element comprises:
a group of first light guide columns arranged along the first direction, wherein each of the first light guide columns has a first indicator terminal running through the first observation hole, and the first light guide column is capable of receiving light from the LED light on one of the board surfaces of the printed circuit board along a second direction perpendicular to the printed circuit board and guiding the light to the first indicator terminal, and
a group of second light guide columns arranged along the first direction, wherein each of the second light guide columns is disposed on a side of the printed circuit board along a third direction perpendicular to the indicator panel, each of the second light guide columns has a second indicator terminal running through the second observation hole, and the second light guide column is capable of receiving light from the LED light on the other of the board surfaces of the printed circuit board along the third direction and guiding the light to the second indicator terminal.

2. The light guide assembly for an electronic device according to claim 1, wherein:
each of the first light guide columns has a first receiving surface perpendicular to the second direction and a first refraction surface; and
light entering the first light guide column from the first receiving surface along the second direction is refracted by the first refraction surface, propagated along the third direction, and guided out from the first indicator terminal.

3. The light guide assembly for an electronic device according to claim 1, wherein:
each of the second light guide columns has a second receiving surface perpendicular to the third direction and two second refraction surfaces; and
the two second refraction surfaces are capable of successively refracting light entering from the second receiving surface along the third direction to light traveling along the third direction and guiding out the light from the second indicator terminal.

4. The light guide assembly for an electronic device according to claim 1, wherein the light guide element further comprises:
a plurality of transverse connection ribs, wherein each of the transverse connection ribs is connected to adjacent two of the first light guide columns or adjacent two of the second light guide columns along the first direction; and
two longitudinal connection ribs, wherein one of the longitudinal connection ribs is connected to the first light guide column and the second light guide column arranged on one end along the first direction, and the other of the longitudinal connection ribs is connected to the first light guide column and the second light guide column arranged on the other end along the first direction.

5. The light guide assembly for an electronic device according to claim 4, wherein:
the light guide element further comprises two reinforcement ribs;
one of the reinforcement ribs is connected to each of the first light guide columns and each of the transverse connection ribs connecting the first light guide columns; and
the other of the reinforcement ribs is connected to each of the second light guide columns and each of the transverse connection ribs connecting the second light guide columns.

6. The light guide assembly for an electronic device according to claim 5, wherein:
the indicator panel includes two snaps and a plurality of stop blocks;
the two snaps are disposed along the first direction;
the two longitudinal connection ribs are capable of engaging with the two snaps;
the two snaps are abutted against the two longitudinal connection ribs to restrict a position of the light guide element in the first direction and abutted against the transverse connection ribs in cooperation with the plurality of stop blocks to restrict a position of the light guide element in the third direction; and
the plurality of stop blocks are further capable of abutting against the transverse connection rib and the reinforcement rib along a direction reverse to the second direction, and abutting against the two longitudinal connection ribs along the second direction in cooperation with the printed circuit board to restrict a position of the light guide element in the second direction.

7. The light guide assembly for an electronic device according to claim 6, further comprising a drive bevel defined at one end, proximate the indicator panel along the third direction, of each of the longitudinal connection ribs;
wherein the drive bevel is capable of driving the snap to deform along the first direction.

8. The light guide assembly for an electronic device according to claim 4, wherein:
each of the transverse connection ribs comprises two connection portions;
each of the connection portions is connected to one of the first light guide columns or one of the second light guide columns along the first direction; and
the two connection portions are connected along a direction perpendicular to the first direction.

9. An electronic device comprising:
a printed circuit board with a plurality of LED lights are disposed on each of two board surfaces at an edge of the printed circuit board; and
light guide assembly for an electronic device having a printed circuit board and a plurality of light emitting diode (LED) lights disposed on each of two board surfaces at an edge of the printed circuit board, the light guide assembly comprising:
a housing with an indicator panel, wherein the printed circuit board is capable of being disposed perpendicular to the indicator panel on the housing;
a row of first observation holes in the indicator panel;
a row of second observation holes in the indicator panel;
wherein the row of first observation holes and the row of second observation holes are respectively arranged along a first direction parallel to the printed circuit board and the indicator panel; and
a light guide element fixed to the indicator panel, wherein the light guide element comprises:
a group of first light guide columns arranged along the first direction, wherein each of the first light guide columns has a first indicator terminal running through the first observation hole, and the first light guide column is capable of receiving light from the LED light on one of the board surfaces of the printed circuit board along a second direction perpendicular to the printed circuit board and guiding the light to the first indicator terminal, and
a group of second light guide columns arranged along the first direction, wherein each of the second light guide columns is disposed on a side of the printed circuit board along a third direction perpendicular to the indicator panel, each of the second light guide columns has a second indicator terminal running through the second observation hole, and the second light guide column is capable of receiving light from the LED light on the other of the board surfaces of the printed circuit board along the third direction and guiding the light to the second indicator terminal;
wherein the first light guide column is capable of receiving light from the LED light on one of the board surfaces of the printed circuit board along a second direction perpendicular to the printed circuit board and guiding the light to the first indicator terminal;
the second light guide column is capable of receiving light from the LED light on the other of the board surfaces of the printed circuit board along the third direction and guiding the light to the second indicator terminal.

10. The electronic device according to claim 9, wherein the LED light on one board surface of the printed circuit board is configured to emit the light to the second light guide column along the third direction.
